(19) United States
(12) Patent Application Publication
(10) Pub. No.: US 2012/0054228 A1
(43) Pub. Date: Mar. 1, 2012

(54) METHOD AND SYSTEM FOR PLAYING MULTIMEDIA FILE AND ATTACHED INFORMATION THEREOF

(75) Inventors: Hsiang-Chun Liu, Taoyuan County (TW); Ju-Hung Hsiao, Tainan City (TW); Yan-Zhang Huang, Taipei County (TW)

(73) Assignee: Gemtek Technology Co., Ltd., Hsinchu (TW)

(21) Appl. No.: 12/938,337

(22) Filed: Nov. 2, 2010

(30) Foreign Application Priority Data
Aug. 24, 2010 (TW) 99128280

(51) Int. Cl. G06F 17/30

(52) U.S. Cl. 707/769; 707/E17.014

(57) ABSTRACT

A method and a system for playing a multimedia file and attached information thereof, suitable for a multimedia file play system comprising a service end and a client end are provided. In the present method, the client end sends a play request of a multimedia file to the service end. The service end searches for attached information of the multimedia file according to the received play request, creates a resource item in a description file to add a link of the attached information, creates an extended field in the resource item to add identification information of the attached information, and returns the description file to the client end. The client end identifies the attached information according to the identification information and downloads the multimedia file and the attached information thereof according to the link, so as to play the multimedia and the attached information.

### CROSS-REFERENCE TO RELATED APPLICATION

This application claims the priority benefit of Taiwan application serial no. 99128280, filed on Aug. 24, 2010. The entirety of the above-mentioned patent application is hereby incorporated by reference herein and made a part of specification.

### BACKGROUND

1. Field of the Invention

The invention relates to a method and a system for playing media. More particularly, the invention relates to a method and a system for playing a multimedia file and attached information thereof.

2. Description of Related Art

Digital living network alliance (DLNA) is an industry standard customized by a plurality of related practitioners, which is constructed based on a universal plug and play (UPnP) technique, and a digital multimedia technique is integrated to conveniently share multimedia files such as pictures, music, movies and play lists, etc.

Devices used for the DLNA may include a digital media server (DMS), a digital media player (DMP), a digital media controller (DMC) and a digital media render (DMR). The DMS may send a description file of a multimedia file to the DMP or the DMC, and the multimedia file may be played by the DMP, or played on the DMR through the DMC. The above devices are communicated through a common language and a common channel, so that video/audio data can be shared without additionally installing drivers or using special wires.

However, in the DLNA specification, a resource item assigned to the DMP by the DMS only includes a field of the multimedia file itself, so that the movies or the music (one or a plurality of songs) can only be shared alone. In case that a movie file and a subtitle file are separated, the player cannot simultaneously play the subtitle file while playing the movie file. Moreover, in case that an audio file and a lyric file are separated, the player cannot simultaneously play the lyric file while playing the audio file.

### SUMMARY OF THE INVENTION

Accordingly, the invention is directed to a method and a system for playing a multimedia file and attached information thereof, by which a player of a digital living network alliance (DLNA) system can simultaneously play the multimedia file and the attached information thereof.

The invention provides a method for playing a multimedia file and attached information thereof, which is adapted to a multimedia file play system comprising a service end and a client end. In the method, the client end sends a play request of the multimedia file to the service end. The service end searches for attached information of the multimedia file according to the play request, creates a resource item in a description file to add a link of the attached information, creates an extended field in the resource item to add identification information of the attached information, and returns the description file to the client end. The client end identifies the attached information according to the identification information and downloads the multimedia file and the attached information according to the link for playing the multimedia and the attached information.

In an embodiment of the invention, the step that the service end searches for the attached information of the multimedia file according to the play request includes that the service end searches the attached information stored therein, and generates the link according to a network address of the service end and a storage position of the attached information.

In an embodiment of the invention, before the step that the service end searches for the attached information of the multimedia file according to the play request, the service end further scans at least one multimedia file stored therein, and connects a multimedia information server on a network to search the attached information of the at least one multimedia file, and downloads the attached information of the at least one multimedia file for storing at a storage position.

In an embodiment of the invention, the step that the service end searches for the attached information of the multimedia file according to the play request includes that the service end connects a multimedia information server on a network to search the attached information of the multimedia file, and downloads the attached information for storing at a storage position, and generates the link according to a network address of the service end and the storage position of the attached information.

In an embodiment of the invention, the step that the service end searches for the attached information of the multimedia file according to the play request includes that the service end connects a multimedia information server on a network to search the attached information of the multimedia file, and stores a network link of the attached information to serve as the link of the attached information.

In an embodiment of the invention, the step that the client end downloads the multimedia file and the attached information according to the link for playing the multimedia and the attached information includes that the client end connects the multimedia information server on the network according to the network link in the resource item to download the multimedia file and the attached information, so as to play the multimedia file and the attached information.

In an embodiment of the invention, the step that the service end searches for the attached information of the multimedia file according to the play request includes that the service end determines a language used by the client end according to a network address of the client end, and searches for the attached information of the language.

In an embodiment of the invention, the step that the service end creates the extended field in the resource item to add the identification information of the attached information includes creating other extended fields in the resource item to add a size, a language and a function description of the attached information.

In an embodiment of the invention, the attached information of the multimedia file includes a subtitle file, a lyric file, a text file, an audio file or a video file, the multimedia file play system is a digital living network alliance (DLNA) system, the service end is a digital media server (DMS), and the client end is a digital media player (DMP) or a digital media controller (DMC).

The invention provides a system for playing a multimedia file and attached information thereof, which includes a service end and a client end. The service end stores at least one multimedia file, and searches for attached information of the multimedia file according to a play request of one of the at least one multimedia file, and creates a resource item in a description file to add a link of the attached information, creates an extended field in the resource item to add identification information of the attached information, and returns the description file. The client end is connected to the service end through a network for sending the play request to the service end and receiving the description file returned by the service end, identifies the attached information according to the identification information and downloads the multimedia file and the attached information according to the link for playing the multimedia and the attached information.

According to the above descriptions, in the method and the system for playing the multimedia file and the attached information thereof, the service end searches the attached information of the stored multimedia file on the network, and downloads the attached information or obtains the network link of the attached information, and creates the resource item in the description file provided to the client end to record the link of the attached information, so that the client end can simultaneously play the attached information while playing the multimedia file.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram illustrating a system for playing a multimedia file and attached information thereof according to a first embodiment of the invention.

FIG. 2 is a flowchart illustrating a method for playing a multimedia file and attached information thereof according to a first embodiment of the invention.

FIG. 3 is a diagram illustrating an example of a description file according to an embodiment of the invention.

FIG. 4 is a system block diagram illustrating a system for playing a multimedia file and attached information thereof according to a second embodiment of the invention.

FIG. 5 is a flowchart illustrating a method for playing a multimedia file and attached information thereof according to a second embodiment of the invention.

### DETAILED DESCRIPTION OF DISCLOSED EMBODIMENTS

Since a digital living network alliance (DLNA) specification only supports playing a multimedia file and displaying a play list, if the multimedia file and attached information thereof (for example, an attached subtitle file/lyric file) are required to be simultaneously played, when a digital media server (DMS) sends a description file to a digital media player (DMP) or a digital media controller (DMC), a resource item of the attached information has to be added to the description file, and an extended field has to be created in the resource item to indicate that data linked by the resource item is the attached information of the multimedia file.

### First Embodiment

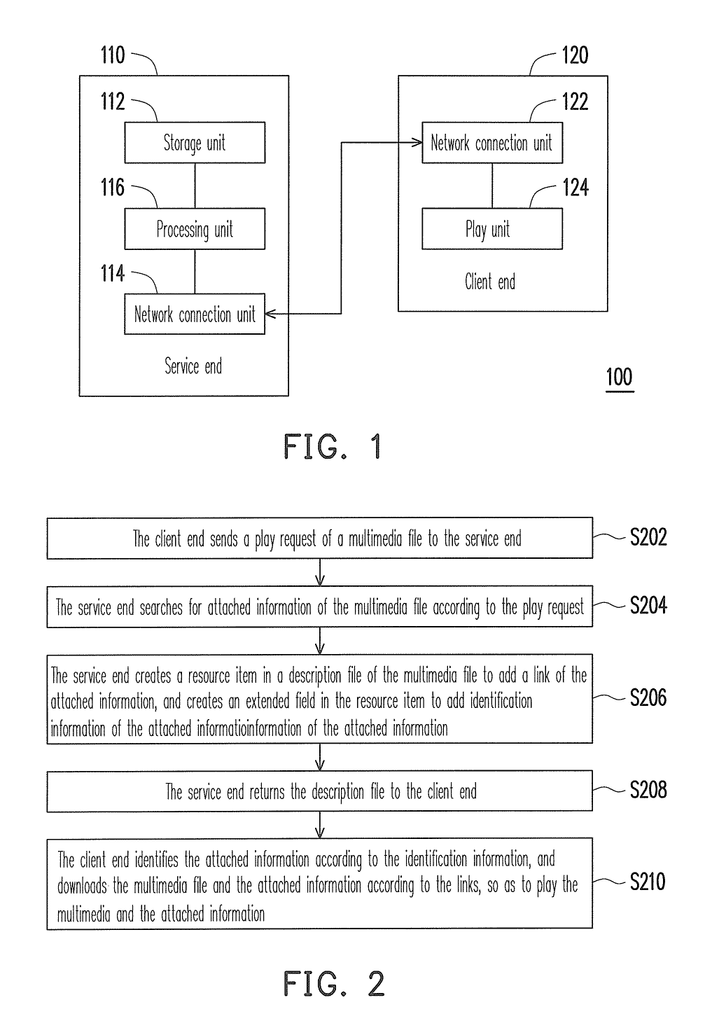

FIG. 1 is a system block diagram illustrating a system for playing a multimedia file and attached information thereof according to a first embodiment of the invention. Referring to FIG. 1, the multimedia file play system 100 of the present embodiment is, for example, a DLNA system, which includes a service end 110 and a client end, and functions thereof are described as follows.

The service end 110 is, for example, a digital media server (DMS) using the DLNA specification, which includes a storage unit 112, a network connection unit 114, and a processing unit 116. Wherein, the storage unit 112 is, for example, any type of a fixed or movable random access memory (RAM), read-only memory (ROM), flash memory, hard disk or other similar devices, which is used for storing at least one multimedia file and attached information of the multimedia files. The multimedia file can be an audio file or a video file, and the attached information is, for example, a subtitle file, a lyric file, a text file, an audio file or a video file related to the multimedia file. The network connection unit 114 connects the client end 120 through a network, and receives a play request of the multimedia file sent by the client end 120. The processing unit 116 is, for example, a central processing unit (CPU), or a programmable general-purpose or special-purpose microprocessor, a digital signal processor (DSP) or other similar devices. The processing unit 116 searches the attached information related to the multimedia file that is stored in the storage unit 112 according to the play request of the multimedia file sent by the client end 120, so as to provide the multimedia file and the attached information thereof to the client end 120 for playing.

The client end 120 is, for example, a digital media play (DMP) or a digital media controller (DMC) using the DLNA specification, which includes a network connection unit 122 and a play unit 124. Wherein, the network connection unit 122 is connected to the service end 110 through the network, and is used for sending the play request of the multimedia file to the service end 110. The play unit 124 may download the multimedia file and the attached information thereof from the service end 110 through the network connection unit 122 for playing.

It should be noticed that the service end 110 returns a description file of the multimedia file according to the play request of the client end 120, wherein the description file records links of the multimedia file and the attached information thereof, so that the client end 120 can download the multimedia file and the attached information according to the links for playing. Implementing method of the first embodiment is described in detail below.

FIG. 2 is a flowchart illustrating a method for playing a multimedia file and attached information thereof according to the first embodiment of the invention. The method of the present embodiment is adapted to the multimedia file play system 100 of FIG. 1, and steps of the method are described in detail with reference of the components shown in FIG. 1.

First, the client end 120 sends a play request of a multimedia file to the service end 110 (step S202). Wherein, the client end 120, for example, sends the play request of the multimedia file to the service end 110 through a connection between the network connection unit 122 and the network connection unit 114 of the service end 110 according to a command sent by a user.

Then, the service end 110 searches attached information of the multimedia file stored in the storage unit 112 according to the play request (step S204). In detail, in an embodiment, the service end 110, for example, scans the multimedia files stored in the storage unit 112 in advance before receiving the play request, and connects a multimedia information server on the network through the network connection unit 114, so as to search the attached information of the multimedia files and download the searched attach information to the storage unit 112 for storage. Accordingly, after receiving the play request from the client end 120, the service end 110 can directly provide the attached infatuation to the client end 120. Moreover, in another embodiment, the service end 110 can also connects the multimedia information server on the network through the network connection unit 114 when receiving the play request, so as to search the attached information of the multimedia files and download the searched attached information to the storage unit 112 for storage.

Then, the service end 110 creates a resource item in a description file returned back to the client end 120 to add a link of the attached information, and creates an extended field in the resource item to add identification information of the attached information (step S206), and then returns the description file to the client end 120 (step S208). In detail, the service end 110 searches the attached information stored in the storage unit 112, and generates the link of the attached information according to a network address of the service end 110 and a storage position of the attached information. The link is recorded in the resource item defined by the DMS (the service end 110), and in the created resource item, an extended field is created to represent whether the file of the link is the attached information, or other extended fields are created in the resource item to represent a size, a language and a function description of the attached information, so that the client end 120 can identify and download the attached information.

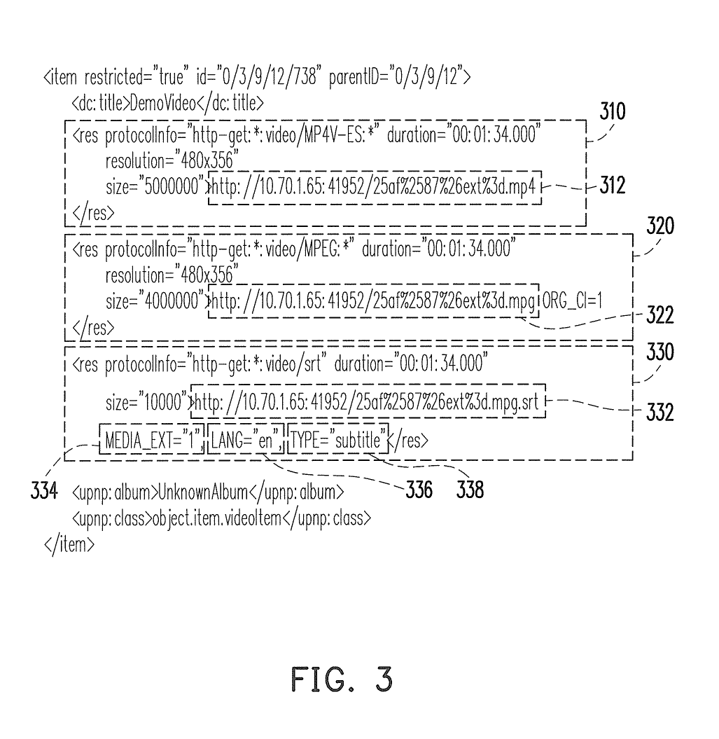

For example, FIG. 3 is a diagram illustrating an example of the description file according to an embodiment of the invention. Referring to FIG. 3, taking movie files as an example, the DMS provides the movie files of a MPEG-4 (an extension name thereof is .mp4) format and a MPEG-2 (an extension name thereof is .mpg) format. A description file 300 of the present embodiment includes resource items 310, 320 and 330, wherein the resource items 310 and 320 respectively record links 312 and 322 of the movie files of the MPEG-4 and MPEG-2 formats. The resource item 330 records a link 332 of a subtitle file of the movie files, and related information of the subtitle file are respectively recorded in extended fields 334, 336 and 338. Wherein, the extended field 334 records identification information of the subtitle file for notifying the DMP or the DMC that the file of such link is the attached information. The extended field 336 records a language type (i.e. English) of the attached information, and the extended field 338 records a type (i.e. the subtitle) of the attached information.

Finally, the client end 120 identifies the attached information according to the identification information of the received description file, and downloads the multimedia file and the attached information according to the links, so as to play the multimedia and the attached information (step S210). In detail, in an embodiment, the DMP uses an extensible markup language (XML) parser parses the identification infatuation recorded in the extended field, and identifies that the link in the resource item where such extended field locates is the attached information. Then, according to the link in such resource item and links recorded in other resource items, the DMP may download the multimedia files and the attached information from the service end 110 for playing.

Moreover, in another embodiment, the DMC adds the attached information obtained from the DMS in the link or a metadata field of the multimedia file for sending to a digital media render (DMR). The DMR parses the attached information from the link or the metadata field of the multimedia file according to a control command of the DMC, and adds the attached information to a play program, so as to play it together with the multimedia file.

According to the above method for playing the multimedia file, the DMP or DMR may simultaneously play the subtitle file while playing the movie file, and simultaneously play a lyric file while playing an audio file, and even simultaneously play attached music while playing a picture file, so as to achieve a diversified multimedia file play effect.

It should be noticed that besides downloading the attached information from the service end to the client end for playing, the service end can also record a link of the attached information on the network, and provide the link to the client end, so that the client end itself can download the attached information for playing. In this way, flexibility of playing the multimedia file is increased. Another embodiment is provided for description.

### Second Embodiment

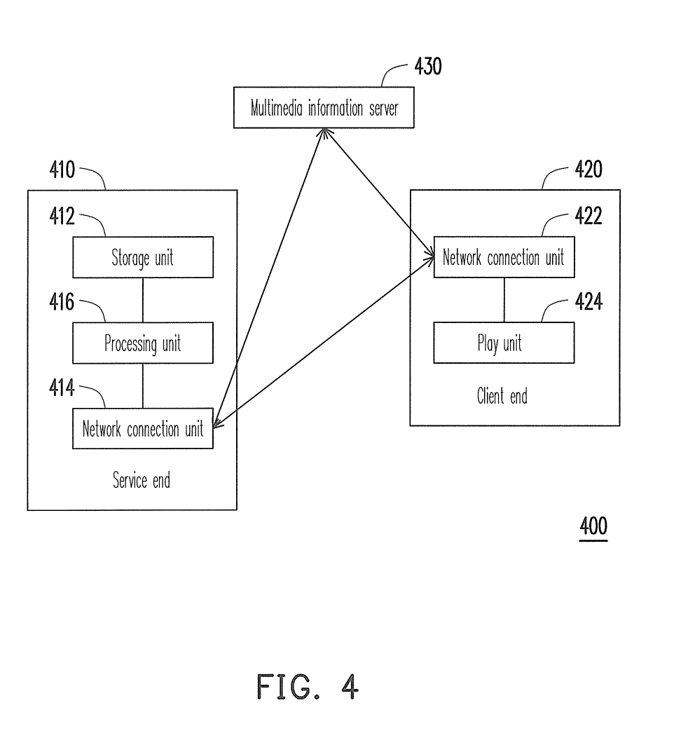

FIG. 4 is a system block diagram illustrating a system for playing a multimedia file and attached information thereof according to a second embodiment of the invention. Referring to FIG. 4, the multimedia file play system 400 is, for example, a DLNA system, which includes a service end 410, a client end 420 and a multimedia information server 430, and functions thereof are described as follows.

The service end 410 is, for example, a DMS using the DLNA specification, which includes a storage unit 412, a network connection unit 414, and a processing unit 416. The client end 420 is, for example, a DMP or a DMC using the DLNA specification, which includes a network connection unit 422 and a play unit 424. Wherein, functions of the components of the service end 410 and the client end 420 are the same as or similar to that of the service end 110 and the client end 120 of the first embodiment, so that detailed descriptions thereof are not repeated.

A difference between the second embodiment and the first embodiment is that the multimedia file play system 400 further includes the multimedia information server 430 on the network. The multimedia information server 430 is, for example, a website capable of providing movie subtitle files or lyric files, in which a database of the movie subtitle files or the lyric files is, for example, already established, and other devices on the network can access the database.

In the present embodiment, after the service end 410 receives a play request from the client end 420, the service end 410 searches the attached information of the multimedia file in the multimedia information server 430, and provides a link of the attached information to the client end 420 for downloading and playing. Implementation of the second embodiment is described in detail below.

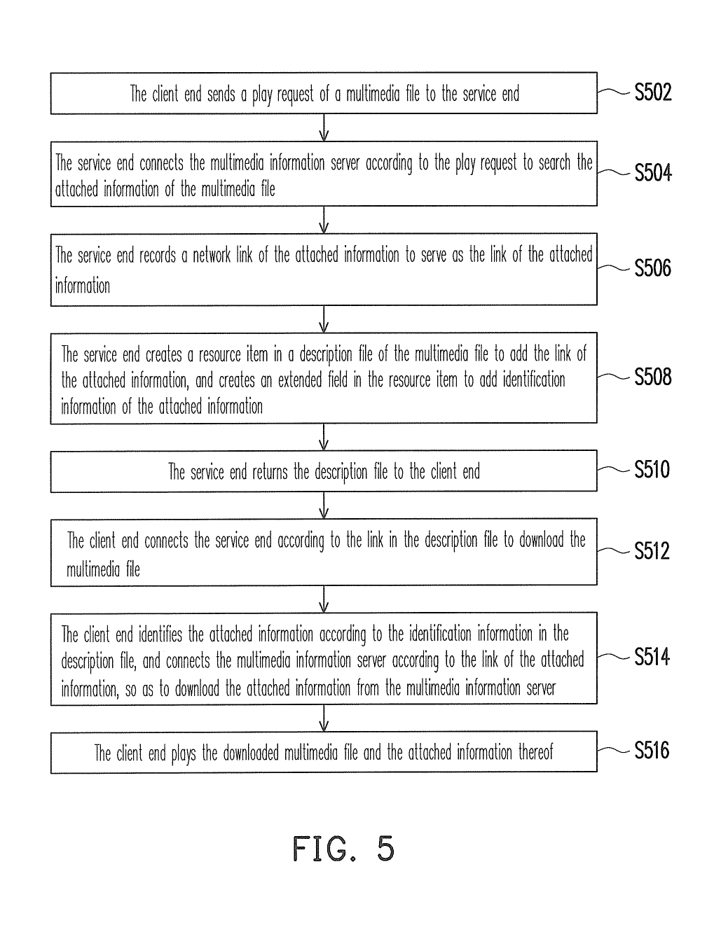

FIG. 5 is a flowchart illustrating a method for playing a multimedia file and attached information thereof according to the second embodiment of the invention. The method of the present embodiment is adapted to the multimedia file play system 400 of FIG. 4, and steps of the method are described in detail with reference to the components shown in FIG. 4.

First, the client end 420 sends a play request of a multimedia file to the service end 410 through the network connection unit 422 (step S502). Then, according to the play request, the processing unit 416 of the service end 410 connects the multimedia information server 430 through the network connection unit 414 for searching the attached information of the multimedia file (step S504).

After the processing unit 416 finds the attached information, the processing unit 416 records a network link of the attached information in the storage unit 412 to serve as the link of the attached information (step S506), and creates a resource item in a description file returned back to the client end 420 to add the link of the attached information, and creates an extended field in the resource item to add identification information of the attached information (step S508), and returns the description file to the client end 420 (step S510).

After the client end 420 receives the description file, in addition to connect the service end 410 through the network connection unit 422 according to the link in the description file for downloading the multimedia file (step 512), the client end 420 further identifies the attached information according to the identification information in the description file, and connects the multimedia information server 430 through the network connection unit 422 according to the link of the attached information, so as to download the attached information from the multimedia information server 430 (step S514). Finally, the client end 420 plays the downloaded multimedia file and the attached information thereof (step S516).

According to the above method for playing the multimedia file, the DMP or DMR may simultaneously play a subtitle file while playing a movie file, and simultaneously play a lyric file while playing an audio file, and even simultaneously play attached music while playing a picture file, so as to achieve a diversified multimedia file play effect.

In summary, according to the method and the system for playing the multimedia file and the attached information thereof, in the description file provided to the DMP or DMR by the DMS, a resource item is created to record the link of the attached information, and an extended field is created in the resource item to record the identification information of the attached information, so that the DMP or DMR can identify the attached information, and download the attached information from the DMS or the multimedia information server on the network according to the link, so as to achieve an effect of simultaneously playing the multimedia file and the attached information thereof.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for playing a multimedia file and attached information thereof, adapted to a multimedia file play system comprising a service end and a client end, and the method comprising:
the client end sending a play request of the multimedia file to the service end;
the service end searching for the attached information of the multimedia file according to the play request;
the service end creating a resource item in a description file to add a link of the attached information, and creating an extended field in the resource item to add identification information of the attached information;
the service end returning the description file to the client end; and
the client end identifying the attached information according to the identification information and downloading the multimedia file and the attached information according to the link for playing the multimedia and the attached information.

2. The method for playing the multimedia file and the attached information thereof as claimed in claim 1, wherein the step of the service end searching for the attached information of the multimedia file according to the play request comprises:
the service end searching the attached information stored therein; and
the service end generating the link according to a network address of the service end and a storage position of the attached information.

3. The method for playing the multimedia file and the attached information thereof as claimed in claim 1, wherein before the step of the service end searching for the attached information of the multimedia file according to the play request, the method further comprises:
the service end scanning at least one multimedia file stored therein;
the service end connecting a multimedia information server on a network to search the attached information of the at least one multimedia file; and
the service end downloading the attached information of the at least one multimedia file for storing at a storage position.

4. The method for playing the multimedia file and the attached information thereof as claimed in claim 1, wherein the step of the service end searching for the attached information of the multimedia file according to the play request comprises:
the service end connecting a multimedia information server on a network to search the attached information of the multimedia file;
the service end downloading the attached information for storing at a storage position; and
the service end generating the link according to a network address of the service end and the storage position of the attached information.

5. The method for playing the multimedia file and the attached information thereof as claimed in claim 1, wherein the step of the service end searching for the attached information of the multimedia file according to the play request comprises:
the service end connecting a multimedia information server on a network to search the attached information of the multimedia file; and
the service end storing a network link of the attached information to serve as the link of the attached information.

6. The method for playing the multimedia file and the attached information thereof as claimed in claim 5, wherein the step of the client end downloading the multimedia file and the attached information according to the link for playing the multimedia and the attached information comprises:
the client end connecting the multimedia information server on the network according to the network link in the resource item to download the multimedia file and the attached information, so as to play the multimedia file and the attached information.

7. The method for playing the multimedia file and the attached information thereof as claimed in claim 1, wherein the step of the service end searching for the attached information of the multimedia file according to the play request comprises:
the service end determining a language used by the client end according to a network address of the client end; and
the service end searching for the attached information of the language.

8. The method for playing the multimedia file and the attached information thereof as claimed in claim 1, wherein the step of the service end creating the extended field in the resource item to add the identification information of the attached information comprises:
creating other extended fields in the resource item to add a size, a language and a function description of the attached information.

9. The method for playing the multimedia file and the attached information thereof as claimed in claim 1, wherein the attached information of the multimedia file comprises a subtitle file, a lyric file, a text file, an audio file or a video file.

10. The method for playing the multimedia file and the attached information thereof as claimed in claim 1, wherein the multimedia file play system is a digital living network alliance (DLNA) system, the service end is a digital media server (DMS), and the client end is a digital media player (DMP) or a digital media controller (DMC).

11. A system for playing a multimedia file and attached information thereof, comprising:
a service end, storing at least one multimedia file, and searching for attached information of the multimedia file according to a play request of one of the at least one multimedia file, creating a resource item in a description file to add a link of the attached information, creating an extended field in the resource item to add identification information of the attached information, and returning the description file; and
a client end, connected to the service end through a network, for sending the play request to the service end, receiving the description file returned by the service end, identifying the attached information according to the identification information, and downloading the multimedia file and the attached information according to the link for playing the multimedia and the attached information.

12. The system for playing the multimedia file and the attached information thereof as claimed in claim 11, wherein the service end comprises:
a storage unit, storing the attached information of the at least one multimedia file;
a first network connection unit, connected to the client end through the network, for receiving the play request of the client end; and
a processing unit, searching the attached information stored in the storage unit according to the play request, and generating the link according to a network address of the storage unit and a storage position of the attached information.

13. The system for playing the multimedia file and the attached information thereof as claimed in claim 11, further comprising:
a multimedia information server, storing the attached information of the at least one multimedia file.

14. The system for playing the multimedia file and the attached information thereof as claimed in claim 13, wherein the processing unit scans the at least one multimedia file stored in the storage unit, connects the multimedia information server through the first network connection unit to search the attached information of the at least one multimedia file, and downloads the attached information of the at least one multimedia file for storing at a storage position in the storage unit.

15. The system for playing the multimedia file and the attached information thereof as claimed in claim 13, wherein the processing unit connects the multimedia information server through the first network connection unit according to the received play request of the multimedia file to search the attached information of the multimedia file, and downloads the attached information for storing at a storage position in the storage unit.

16. The system for playing the multimedia file and the attached information thereof as claimed in claim 13, wherein the processing unit further connects the multimedia information server through the first network connection unit according to the received play request of the multimedia file to search the attached information of the multimedia file, and records a network link of the attached information to serve as the link of the attached information.

17. The system for playing the multimedia file and the attached information thereof as claimed in claim 16, wherein the client end comprises:
a second network connection unit, for connecting the multimedia information server on the network according to the network link in the resource item; and
a play unit, for downloading the multimedia file and the attached information from the multimedia information server through the second network connection unit, so as to play the multimedia file and the attached information.

18. The system for playing the multimedia file and the attached information thereof as claimed in claim 11, wherein the service end determines a language used by the client end according to a network address of the client end, and searches for the attached information of the language.

19. The system for playing the multimedia file and the attached information thereof as claimed in claim 11, wherein the service end further creates other extended fields in the resource item to add a size, a language and a function description of the attached information.

20. The system for playing the multimedia file and the attached information thereof as claimed in claim 11, wherein the attached information of the multimedia file comprises a subtitle file, a lyric file, a text file, an audio file or a video file.

21. The system for playing the multimedia file and the attached information thereof as claimed in claim 11, wherein the system for playing the multimedia file and the attached information thereof is a digital living network alliance (DLNA) system, the service end is a digital media server (DMS), and the client end is a digital media player (DMP) or a digital media controller (DMC).
